(19) United States
(12) Patent Application Publication
(10) Pub. No.: US 2014/0348101 A1
(43) Pub. Date: Nov. 27, 2014

(54) BUFFER RESOURCE MANAGEMENT METHOD AND TELECOMMUNICATION EQUIPMENT

(71) Applicant: Optis Cellular Technology, LLC, Plano, TX (US)

(72) Inventor: Jun Wang, Jiangsu (CN)

(21) Appl. No.: 14/365,470

(22) PCT Filed: Dec. 14, 2011
(86) PCT No.: PCT/CN2011/083973

§ 371 Date: Jun. 13, 2014

(51) Int. Cl. H04W 72/12; H04W 88/08

(52) U.S. Cl. CPC H04W 72/1221; H04W 88/08
USPC 370/329

(57) ABSTRACT

The present disclosure relates to a lockless buffer resource management scheme. In the proposed scheme, a buffer pool is configured to have an allocation list and a de-allocation list. The allocation list includes one or more buffer objects linked by a next pointer in a previous buffer object to a next buffer object, and a head pointer pointing to a buffer object at the head of the allocation list. The de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer.

### TECHNICAL FIELD

The disclosure relates to lockless solution of resource management, and more particularly, to a lockless buffer resource management scheme and a telecommunication equipment employing the same.

### BACKGROUND

In telecommunication equipments such as BS (Base Station) and/or switch, there are always needs for managing buffer resources therein. For example, in LTE (Long Term Evolution) eNB (evolved Node B), the incoming/outgoing packet at S1 interface is a concurrent and asynchronous procedure compared with that in air interface. Usually there are two separate tasks, one receives or sends through socket on S1 interface and delivers packets to the radio UP (User Plane) (PDCP/RLC/MAC) stack, and the other makes MAC (Media Access Control) PDU (Packet Data Unit) according to scheduling information from packets in UP stack and transmits on air interface.

FIG. 1 shows an exemplary producer and consumer model in LTE eNB. The socket task (on S1 interface) is consumer which allocates a buffer object from pool to hold packet from S1 interface and transfer it to UP stack, and the other task (on air interface) is producer which releases the buffer object back to the pool after the PDU is transmitted through air interface. The buffer object is a container of packet flowing between the two tasks, thus recycled in a buffer pool for reuse. Then, a common issue comes up that how to guarantee the data integrity of buffer pool in such a multi-thread execution environment.

The common method of guarantying data integrity in producer-consumer model is LOCK, which forces the serial access of the buffer pool among multiple threads to ensure the data integrity.

The LOCK mechanism is usually provided by OS (Operating System), which can make sure the atomicity, like mutex, semaphore. Whenever any task wants to access the buffer pool regardless of allocation or de-allocation, it always need acquire LOCK at first. If the LOCK has been owned by another task, the current task will have to suspend its execution until the owner releases the LOCK.

The LOCK mechanism will unavoidably introduce extra task switch. In usual case, it will not cause much impact on the overall performance. However, in some critical real-time environment, the overhead of task switch can NOT be ignored. For example, in LTE eNB, the scheduling TTI is only 1 ms, while the one task switch will consume about 20 μs and one round of task suspension and resumption need at least two task switch procedures, i.e., 40 μs, which becomes a remarkable impact on LTE scheduling performance, especially at heavy traffic volume.

Usually the baseband applications are run at multi-core hardware platform, which facilitates concurrent execution of multiple tasks in parallel to achieve the high performance. However the LOCK mechanism blocks such parallel model, since the essential of LOCK just forces serial execution to ensure data integrity. Even if the interval of owning lock is very small, the serial execution will cause great impact on the applications running on multi-core platform, and may become potential performance bottleneck.

### SUMMARY

To solve at least one of the above problems, a lockless buffer resource management scheme and a telecommunication equipment employing the same are proposed in the present disclosure.

According to a first aspect of the present disclosure, there provides a buffer resource management method, in which a buffer pool is configured to have an allocation list and a de-allocation list. The allocation list includes one or more buffer objects linked by a next pointer in a previous buffer object to a next buffer object, and a head pointer pointing to a buffer object at the head of the allocation list. The de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer. In initialization, the head pointer of the de-allocation list is empty, and the tail pointer of the de-allocation list points to the head pointer itself of the de-allocation list. The buffer resource management method may include steps of a takeover action as: assigning the head pointer of the de-allocation list to the head pointer of the allocation list; cleaning the head pointer of the de-allocation list to empty; and having the tail pointer of the de-allocation list pointing to the head pointer itself of the de-allocation list.

In one embodiment, the buffer resource management method may further include steps of: determining whether or not the allocation list is empty; if the allocation list is empty, determining whether or not the de-allocation list is empty; and if the de-allocation list is not empty, performing the steps of the takeover action. The buffer resource management method may further include steps of: if the allocation list is not empty, unlinking the buffer object at the head of the allocation list. The buffer resource management method may further include steps of: if the de-allocation list is empty, allocating a plurality of buffer objects from a heap, and linking the plurality of buffer objects to the allocation list.

In another embodiment, the buffer resource management method may further include steps of a reclamation action as: having the next pointer of the buffer object at the end of the de-allocation list pointing to a new released buffer object, in which the next pointer of the end of the de-allocation list is addressed by the tail pointer of the de-allocation list; and moving the tail pointer of the de-allocation list to a next pointer of the new released buffer object. The buffer resource management method may further include steps of a post-adjustment action as: after the new released buffer object is linked into the de-allocation list, determining if the head pointer of the de-allocation list is empty or not; and if the head pointer of the de-allocation list is empty, having the tail pointer of de-allocation list pointing to the head pointer itself of the de-allocation list. The buffer resource management method may further include steps of a re-reclamation action as: after the post adjustment action, determining whether or not the head pointer of the allocation list is empty and the new released buffer object is still in a released state; and if the head pointer of the allocation list is empty and the new released buffer object is still in a released state, performing the steps of the reclamation action once more.

As an example, the steps of the takeover action and the steps of the reclamation action can be interleaved at any position(s).

According to a second aspect of the present disclosure, there provides a buffer resource management method, in which a buffer pool is configured to have an allocation list and a de-allocation list. The allocation list includes one or more buffer objects linked by a next pointer in a previous buffer object to a next buffer object, and a head pointer pointing to a buffer object at the head of the allocation list. The de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer. In initialization, the head pointer of the de-allocation list is empty, and the tail pointer of the de-allocation list points to the head pointer itself of the de-allocation list. The buffer resource management method may include steps of a reclamation action as: having the next pointer of the buffer object at the end of the de-allocation list pointing to a new released buffer object, in which the next pointer of the end of the de-allocation list is addressed by the tail pointer of the de-allocation list; and moving the tail pointer of the de-allocation list to a next pointer of the new released buffer object.

In one embodiment, the buffer resource management method may further include steps of a post-adjustment action as: after the new released buffer object is linked into the de-allocation list, determining if the head pointer of the de-allocation list is empty or not; and if the head pointer of the de-allocation list is empty, having the tail pointer of de-allocation list pointing to the head pointer itself of the de-allocation list. The buffer resource management method may further include steps of a re-reclamation action as: after the post adjustment action, determining whether or not the head pointer of the allocation list is empty and the new released buffer object is still in a released state; and if the head pointer of the allocation list is empty and the new released buffer object is still in a released state, performing the steps of the reclamation action once more.

According to a third aspect of the present disclosure, there provides a computer-readable storage medium having computer-readable instructions to facilitate buffer resource management in a telecommunication equipment that are executable by a computing device to carry out the method according to any one of the first and second aspects of the present disclosure.

According to a fourth aspect of the present disclosure, there provides a telecommunication equipment including a buffer pool, wherein the buffer pool is configured to have a de-allocation list. The de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer.

In one embodiment, in initialization, the head pointer of the de-allocation list is empty, and the tail pointer of the de-allocation list points to the head pointer itself of the de-allocation list.

In another embodiment, the buffer pool is further configured to have an allocation list, and the allocation list includes one or more buffer objects linked by a next pointer in a previous buffer object to a next buffer object, and a head pointer pointing to a buffer object at the head of the allocation list.

In still another embodiment, the telecommunication equipment may further include a processor configured to perform steps of a takeover action as: assigning the head pointer of the de-allocation list to the head pointer of the allocation list; cleaning the head pointer of the de-allocation list to empty; and having the tail pointer of the de-allocation list pointing to the head pointer itself of the de-allocation list.

In yet another embodiment, the processor may be further configured to perform steps of: determining whether or not the allocation list is empty; if the allocation list is empty, determining whether or not the de-allocation list is empty; and if the de-allocation list is not empty, performing the steps of the takeover action. The processor may be further configured to perform steps of: if the allocation list is not empty, unlinking the buffer object at the head of the allocation list. The processor may be further configured to perform steps of: if the de-allocation list is empty, allocating a plurality of buffer objects from a heap, and linking the plurality of buffer objects to the allocation list.

In one more embodiment, the processor may further configured to perform steps of a reclamation action as: having the next pointer of the buffer object at the end of the de-allocation list pointing to a new released buffer object, in which the next pointer of the end of the de-allocation list is addressed by the tail pointer of the de-allocation list; and moving the tail pointer of the de-allocation list to a next pointer of the new released buffer object.

Or alternatively, the telecommunication equipment may further include a processor configured to perform steps of a reclamation action as: having the next pointer of the buffer object at the end of the de-allocation list pointing to a new released buffer object, in which the next pointer of the end of the de-allocation list is addressed by the tail pointer of the de-allocation list; and moving the tail pointer of the de-allocation list to a next pointer of the new released buffer object.

Furthermore, the processor may be further configured to perform steps of a post-adjustment action as: after the new released buffer object is linked into the de-allocation list, determining if the head pointer of the de-allocation list is empty or not; and if the head pointer of the de-allocation list is empty, having the tail pointer of de-allocation list pointing to the head pointer itself of the de-allocation list. The processor may be further configured to perform steps of a re-reclamation action as: after the post adjustment action, determining whether or not the head pointer of the allocation list is empty and the new released buffer object is still in a released state; and if the head pointer of the allocation list is empty and the new released buffer object is still in a released state, performing the steps of the reclamation action once more.

As an example, the steps of the takeover action and the steps of the reclamation action can be interleaved at any position(s).

As another example, the telecommunication equipment may be a Base Station (BS), a switch or an evolved Node B (eNB).

### BRIEF DESCRIPTION OF THE DRAWINGS

The above and other objects, features and advantages of the present disclosure will be clearer from the following detailed description about the non-limited embodiments of the present disclosure taken in conjunction with the accompanied drawings, in which:

FIG. 1 is a schematic diagram of one producer and one consumer model.

FIG. 2 shows an example allocation list and an example de-allocation list (also referred to as “free list”) with their buffer objects, headers and tails.

FIG. 3 is a schematic diagram illustrating a buffer object.

FIG. 4 shows a flowchart of an example consumer task.

FIG. 5 shows a flowchart of an example producer task.

FIG. 6 shows a flowchart of an example producer task with buffer loss detection.

### DETAILED DESCRIPTION OF EMBODIMENTS

Hereunder, the embodiments of the present disclosure will be described in accordance with the drawings. In the following description, some particular embodiments are used for the purpose of description only, which shall not be understood as any limitation to the present disclosure but the examples thereof. While it may blur the understanding of the present disclosure, the conventional structure or construction will be omitted.

According to the prior arts, the LOCK mechanism introduces extra task switch overhead and blocks parallel execution, one goal of the present disclosure is just to remove the LOCK but still ensuring the data integrity.

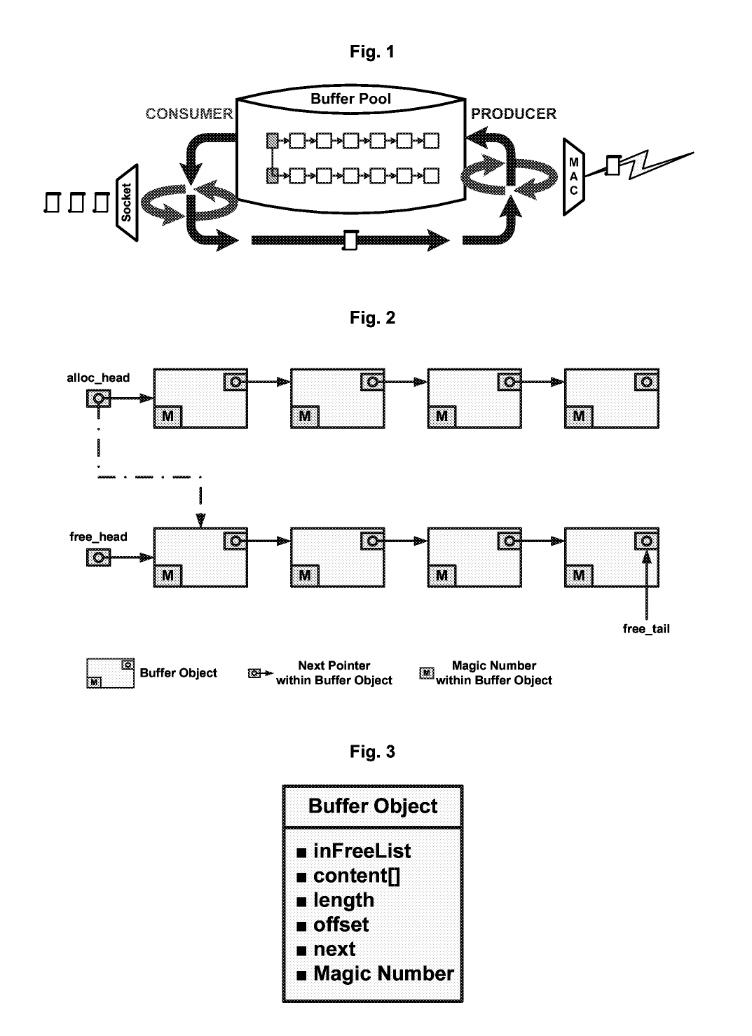

Because modern OS theory has proven that the LOCK mechanism is only one feasible method to resolve the resources contention among multi-task environment. However, such theory is just aimed to a general case, while in some special cases, the LOCK may be not necessary any more. The concerned producer and consumer case as shown in FIG. 1 is just one of such cases, and this case has the following characteristics:
Only two concurrent tasks available Compared to the general case which has more than two tasks, the current producer and consumer case has just two tasks.
One for read and the other for write Compared to the general case where anyone task can both read and write, current producer mainly writes to buffer pool, while the consumer mainly reads from buffer pool.

Where there are only two tasks and each of them performs different operation to a buffer pool, it's possible to have the two tasks to access different parts of the buffer pool through carefully designing the data structure and processing procedure, without using the LOCK.

To fulfill above goal, at least one of the following design principles can be followed.
1. Separate critical data structures to different tasks
   Although no lock is used, the method of isolating data structure still can be used, which can ensure the data integrity to the larger extent.
   For example, in one linked list structure, the list head will become a critical variable accessed by two tasks simultaneously, thus impossible to guarantee its integrity. But if it adopts two separate lists for individual tasks, the contention possibility will be decreased greatly.
   However, at some time, the simultaneous access is still inevitable, and thus it still need introduce more other techniques.
2. Use as smaller number of instructions as possible to access those critical data structures
   When accessing the critical data structure, the if-then-else mode is usually adopted, i.e., checking some condition at first and then operating on data structure according to result. However, such a mode occupies more CPU instructions, then increasing the difficulty of ensuring data integrity. The fewer code instruction, the lower contention possibility. So it is better to try best to adopt uniform processing logic without condition check on the critical data structures through carefully designing the data structure and processing procedure.
3. When simultaneous access of one of critical data structures is inevitable, it is better that operations from different tasks keep compatible each other.
   Regardless of how to design the data structure carefully, the fact that the two tasks operate on same data structure will always happen. Without lock synchronization mechanism, the execution sequences of two tasks on the data structure are random, thus the result will become unpredictable. Thus it is better to avoid the conflicting operations from different tasks. Here, “compatibility” in an example means the read-and-write or write-and-write with same result, which can generate deterministic result even if two tasks access data structures at the same time.
   4. When condition check has to be used, it is better to remain the condition unchanged once it's checked TRUE.
   Generally speaking, the condition check is inevitable regardless how to design the processing procedure carefully. Because the condition check is NOT an atomic operation, an unexpected task switch may occur between the check and corresponding operation, and then the condition may vary after the task resumes its execution, causing data corrupt. So if no lock is used, it is better to make sure the condition itself keeps unchanged once it's checked as TRUE or FALSE even if a task switch really occurs between the check and subsequent operation.

In one embodiment of the present disclosure, there provides a lockless resource contention resolution method. In this method, a buffer pool is configured to have an allocation list and a de-allocation list. The allocation list includes one or more buffer objects linked by a next pointer in a previous buffer object to a next buffer object, and a head pointer pointing to a buffer object at the head of the allocation list. The de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer. In initialization, the head pointer of the de-allocation list is empty, and the tail pointer of the de-allocation list points to the head pointer itself of the de-allocation list. The buffer resource management method may include steps of a takeover action as: assigning the head pointer of the de-allocation list to the head pointer of the allocation list, cleaning the head pointer of the de-allocation list to empty, and then having the tail pointer of the de-allocation list pointing to the head pointer itself of the de-allocation list. Before the steps of takeover action are performed, the buffer resource management method may include steps of: if allocation list is not empty, unlinking the buffer object at the head of the allocation list and returning to the consumer task; otherwise, if the de-allocation list is not empty, the allocation list will takeover the de-allocation list by performing the steps of the takeover action. If the de-allocation list is empty, a plurality of buffer objects are allocated from a heap, and are linked to the allocation list; thereafter, returning to the consumer task. The buffer resource management method may further include steps of a reclamation action as: having the next pointer of the buffer object at the end of the de-allocation list (which is addressed by the tail pointer of the de-allocation list) pointing to a new released buffer object, and moving the tail pointer of the de-allocation list to a next pointer of the new released buffer object. The buffer resource management method may further include steps of a post-adjustment action following above reclamation: after the released buffer object is linked to the end of the de-allocation list, if the head pointer of de-allocation list becomes empty (takeover occurs), having the tail pointer of de-allocation list pointing to the head pointer itself of the de-allocation list to keep consistent result with takeover. The buffer resource management method may further include steps of re-reclamation action following above post-adjustment: after post-adjustment, if the head pointer of allocation list becomes empty (buffer object allocated to consumer already) and the new released buffer object is still in a released state, performing the steps of the above reclamation action again to avoid buffer lost.

Based on the above design principle 1, the buffer poll is designed to have two separate lists for allocation and de-allocation respectively. In details, FIG. 2 shows these two separate lists (allocation list, de-allocation list (also referred to as “free list”)) with their buffer objects, headers and tails.

FIG. 2 shows an example allocation list and an example de-allocation list (also referred to as “free list”) with their buffer objects, headers and tails. Referring to FIG. 2, the global pointers are described as follows.
alloc_head
(buffer *) head pointer pointing to allocation list
   the pointer is initialized to NULL;
   it refers to a bulk memory within heap;
   after takeover, it points to the 1^{st} buffer object of de-allocation list.
free_head:
(buffer *) head pointer pointing to de-allocation list
   the pointer is initialized to NULL;
   it points to the 1^{st} buffer object of de-allocation list;
   after takeover, the pointer is reset to NULL again.
free_tail:
(buffer **) tail pointer pointing to next pointer of buffer object at de-allocation list end
   the pointer points to the free_head at initialization;
   each time buffer object is released, the buffer object is linked to end of de-allocation list pointed by free_tail and free_tail is moved to point to next pointer of the released buffer object.
   after takeover, the free_tail is reset to point to free_head again.

In some embodiments of the present disclosure, there provides a telecommunication equipment having a buffer pool, wherein the buffer pool may be configured to have at least one of the de-allocation list and allocation list as shown in FIG. 2. This telecommunication equipment can be a Base Station (BS), a switch, or an evolved Node B (eNB). In detail, the de-allocation list includes: one or more buffer objects linked by a next pointer in a previous buffer object to a next buffer object, a head pointer (free_head) pointing to a buffer object at the head of the de-allocation list, and a tail pointer (free_tail) pointing to a next pointer of a buffer object at the end of the de-allocation list, wherein the tail pointer is a pointer's pointer. The allocation list includes: one or more buffer objects linked by a next pointer in a previous buffer object to a next buffer object, and a head pointer (alloc_head) pointing to a buffer object at the head of the allocation list.

FIG. 3 is a schematic diagram illustrating a buffer object.

Referring to FIG. 3, one buffer object has the following fields.
in FreeList: bool (TRUE: free, FALSE used)
indicating whether the buffer object is in pool or not
The field is set according to the following rules:
   the field is set to TRUE at initialization;
   when consumer task allocates buffer from pool, it is better to set the field to FALSE in prior to unlink from allocation list;
   when producer task releases buffer to pool, it is better to set the field to TRUE in advance to append to de-allocation list;
   when consumer task reclaims buffer to pool, it is better to firstly insert buffer to beginning of allocation list in prior to set the field to TRUE.
content[ ]: char[ ],
holding the incoming packet
for example, maximum 2,500 bytes.
a length:
the actual buffer content length
offset:
the start offset of the content within the array, holding the prefixed the protocol header (PDCP)
next:
next pointer pointing to the subsequent buffer object
magic number:
optional, invisible field indicating the buffer owner
this field is by default populated to PRODUCER, since the buffer object is usually released by producer task but can be modified to CONSUMER when consumer task releases the unused buffer back to pool to enable different processing.

Based on the above design principle 2, instead of normal if-then-else code model, each task just uses a uniform code model only with two instructions to fulfill the critical resources preemption and cleanup work, which has achieved the smaller instruction number. It then greatly decreases possible instruction sequence combination set, and then makes it possible to enumerate all cases, guarantying the algorithm correctness.

The conflict comes from the two tasks interleaving execution, so the algorithm need consider all possible code sequence combination and make sure all possibilities have been enumerated.

Let's assume one task has M−1 instructions, leaving M possible instruction interleaving positions, with which the other task has N instructions to interleave, then the number of all possible code sequence combination is as following:

S(N,M)=S(N−1,M)+S(N−1,M−1)+S(N−1,M−2)+ . . . +S(N−1,1)

If we enumerate N from 1, 2, 3 . . .

$$\begin{matrix}\begin{matrix}\begin{matrix}S ( 1 , M ) = M = O ( M ) \\ \begin{matrix}S ( 2 , M ) = S ( 1 , M ) + S ( 1 , M - 1 ) + S ( 1 , M - 2 ) + … + S ( 1 , 1 ) \\ = M + M - 1 + M - 2 + … + 1 \\ = {( M + 1 )}^{*} M \text{/} 2 \\ = O ( {M}^{2} )\end{matrix}\end{matrix} \\ \begin{matrix}S ( 3 , M ) = S ( 2 , M ) + S ( 2 , M - 1 ) + S ( 2 , M - 2 ) + … + S ( 2 , 1 ) \\ = {( M + 1 )}^{*} M \text{/} 2 + {M}^{*} ( M - 1 ) \text{/} 2 + {( M - 1 )}^{*} ( M - 2 ) \text{/} 2 + … + 1 \\ = O ( {M}^{3} )\end{matrix}\end{matrix} \\ … \\ S ( N , M ) = O ( {M}^{N} )\end{matrix}$$

From above formula, it can be seen that if the M and N are large value, the number of the code combination set will reach a huge value, extremely difficult to cover all possibilities, which is just why the critical code sequence is limited to smaller number of instructions.

In this regards, as detailed later, conflicting operations may still occur during takeover procedure even if the critical code sequence has been reduced to the smaller number of instructions, where the consumer task is designed to have only two critical instructions as {free_head=NULL; free_tail=&free_head}, then leaving three possible interleaving positions and the producer task is designed to have only two critical instructions as {*free_tail=pNodeDel; free_tail=&(pNodeDel→next)}. In actual situations, these instructions of the consumer task and the producer task are interleavable at any position. So, the total number of interleaving code combination set is S(N=2, M=3)=S(1, 3)+S(1, 2)+S(1, 1)=3+2+1=6.

In the actual execution, no one definitely knows which scenario is met (since no check can be done otherwise it will introduce extra interleaving code combination set), so it is better that the final code sequence can guarantee the result is always correct regardless of which scenario happens. Based on the above design principle 3, it is better to carefully choose the action to keep consistent among above all scenarios. For example, during the post-adjustment, the tail pointer of de-allocation list is pulled back pointing to head pointer of de-allocation list once takeover is detected, since the above adjustment of tail pointer is just consistent between takeover and post-adjustment procedures, so it's always correct regardless of how takeover and reclamation actions interleave each other.

Even if the new procedure adopts special design to decrease contention possibility to the smaller extent, the side effect caused by two tasks interleaving execution is still inevitable. Fortunately, it can eliminate the side effect completely through careful checking the footprint of the other task. Upon finding the data structure has been touched by other task, it need do some extra adjustment on the data structure to remove the side effect. Based on the design principle 4, the check condition of data structure touch by other task is safe because once the head pointer of de-allocation list becomes empty, consumer task will NOT touch it any more and it will always keep empty forever until producer task modifies it on purpose, which of course will not conflict with the producer task itself. Then it guarantees the post adjustment correctness.

Based on the above design principles 1-4, the operation descriptions as well as corresponding pseudo codes for the consumer task and producer task are shown as follows.

### Allocation

When a thread requests to allocate buffer from pool through the overloaded new operator, separate processing will be performed according to the thread role.
Consumer
It's a normal scenario. It always attempts to unlink a buffer object from the allocation list head if the link is not empty; otherwise it attempts to take over the de-allocation list from producer thread if the de-allocation list is not empty; otherwise it calls original new function to allocate a bulk of memory from heap to construct a buffer list.
Producer
Allocate buffer from its own producer pool (will be detailed later).

Consumer Task

If (allocation list is EMPTY)
{

if (de-allocation list is EMPTY)
{

```
// ACQUIRE FROM HEAP
  Allocate a block of buffers from heap
  and link them to allocation list
```

}
else

{

// TAKEOVER ACTION
alloc_head = free_head;
free_head = NULL;
free_tail = &free_head;

}

}
// BUFFER OBJECT ALLOCATION
Unlink a buffer object from the head of allocation list

### De-Allocation

Like the allocation procedure, the de-allocation also need distinguish the following two scenarios.
Producer
It only touches the de-allocation list by free_tail pointer, two CPU instructions are enough, i.e., link the buffer object to the end of de-allocation list pointed by free_tail and move the free_tail to current buffer object. After that, it still need a special post adjustment to guarantee the data integrity (will be detailed later), since the de-allocation scenario may happen at same time as the takeover operation of allocation scenario.
Consumer
To avoid the conflict with producer, the de-allocation procedure from consumer task only touches the allocation list by inserting the buffer into the beginning of list.

Producer Task

if (free_tail == &free_head)
{

// RESOLVE CONFLICT WITH TAKEOVER
// MOVE FREE_TAIL TO END OF FREE LIST
while (*free_tail != NULL)
{
free_tail = &(*free_tail)−>next
}

}
// LINK BUFFER OBJECT TO END OF FREE LIST
*free_tail = pNodeDel;
free_tail = & (pNodeDel−>next);
// POST ADJUSTMENT
if (free_head is Empty)
{
free_tail = &free_head;
}

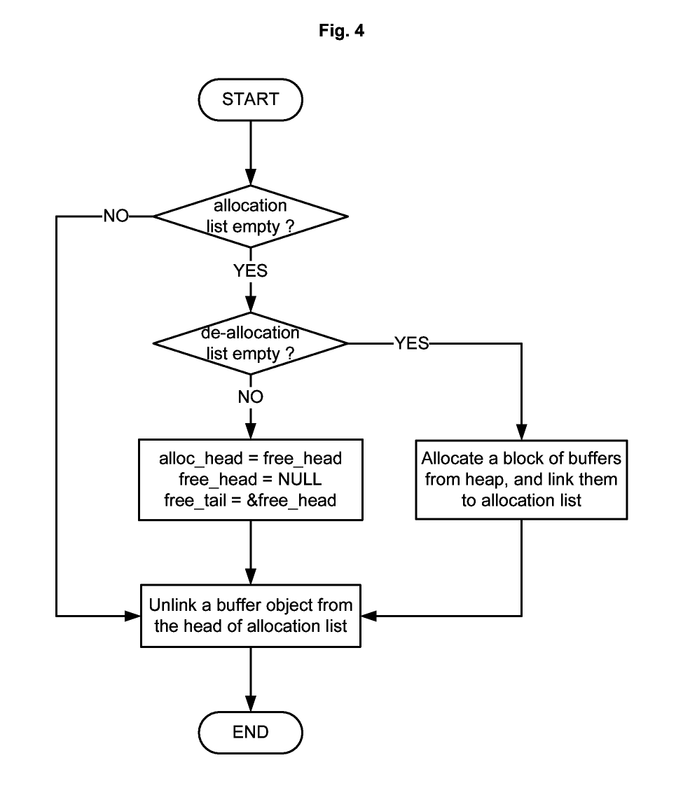

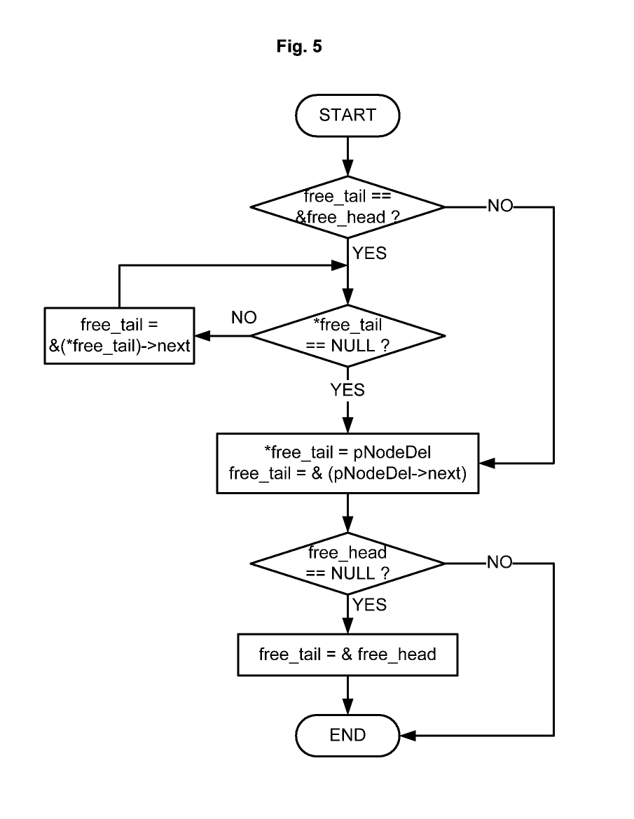

Correspondingly, FIG. 4 shows a flowchart of the example consumer task, and FIG. 5 shows a flowchart of the example producer task.

In some embodiments of the present disclosure, the telecommunication equipment having the buffer pool as shown in FIG. 2 may further include a processor configured to perform one or more steps of the above consumer task and/or one or more steps of the above procedure task.

As mentioned above, the de-allocation may happen simultaneously as take-over operation. Due to code instruction interleave effect, when free_tail is moved to the current released buffer, it may have been taken over by consumer task, then the free_tail point becomes invalid, it may need extra adjustment to keep tail pointer correctness.

To keep data integrity, a post adjustment always follows the de-allocation procedure, which checks free_head. If the free_head is empty, which means takeover has indeed occurred (current de-allocation must not result in empty free_head), then free_tail is reset to free_head, which is duplicate with takeover action, but remains compatible result (of the design principle 3).

Once the free_head is set to empty by takeover action, it will not change any more. So the above check is secure and can be used in post adjustment. However, the check of free_head as nonempty is NOT such case, since nonempty free_head can be reset to empty by takeover action, thus will not be used in post adjustment.

The post adjustment can resolve the conflict between takeover and reclamation, but the buffer loss issue may still exist, which occurs as following:
There is no buffer in allocation list and only one buffer left in de-allocation list.
Exactly before de-allocation gets last object of de-allocation list (the only one buffer object) pointed by free_tail and attempts to link to its next pointer, the task switch occurred, which takes over the only one buffer object from de-allocation list and allocate to consumer task, then the alloc_head is set to NULL again.
The producer task is resumed and proceeds its execution as if nothing happens. Then it still uses the previous buffer object (which has been allocated) to link the released buffer, which will get leaked, since it's no longer referred by any known pointers.

To resolve above buffer loss issue, the buffer loss detection procedure can be introduced. For this purpose, an additional global variable, NewfromHeap (boot), is also defined in the present embodiment, for indicating whether allocation list holds new buffer objects allocated from heap or recycled buffer objects taken over from de-allocation list.
NewfromHeap:
(bool) indicating whether allocation list holds new buffer objects allocated from heap or recycled buffer objects taken over from de-allocation list
   the variable is set to FALSE at initialization;
   each time a bulk memory is allocated from heap and referred by alloc_head, the variable is set to TRUE;
   after takeover, the variable is reset to FALSE.

It's just aimed to above buffer loss condition case by checking following conditions:
free_head==NULL
meaning takeover really occurs, which is the precondition of buffer loss
in FreeList==TRUE
meaning the buffer hasn't been allocated, possible to get lost
(alloc_head==NULL)∥(NewfromHeap)
meaning the only one buffer object taken over from de-allocation list has been allocated, buffer loss occurs.

If above conditions are met, the buffer loss occurs, then it need be reclaimed again. The 2^{nd} reclamation may succeed, since the de-allocation list has been empty, takeover action will not happen again, it can be linked to de-allocation list safely.

In this regard, the producer task's pseudo code can be modified as follows.

Producer Task

for (int i = 0; i < 2; i++)
{

if (free_tail == &free_head)
{

// RESOLVE CONFLICT WITH TAKEOVER
// MOVE FREE_TAIL TO END OF FREE LIST
while (*free_tail != NULL)
{
free_tail = &(*free_tail)−>next
}

```
}
// LINK BUFFER OBJECT TO END OF FREE LIST
*free_tail = pNodeDel;
free_tail = & (pNodeDel−>next);
  // POST ADJUSTMENT
  if (free_head is Empty)
  {
  free_tail = &free_head;
```

// BUFFER LOSS DETECTION
if ( (pNodeDel−>inFreeList == TRUE) &&
(alloc_head == NULL || NewfromHeap) )
{

continue;

}

```
  }
  break;
```

}

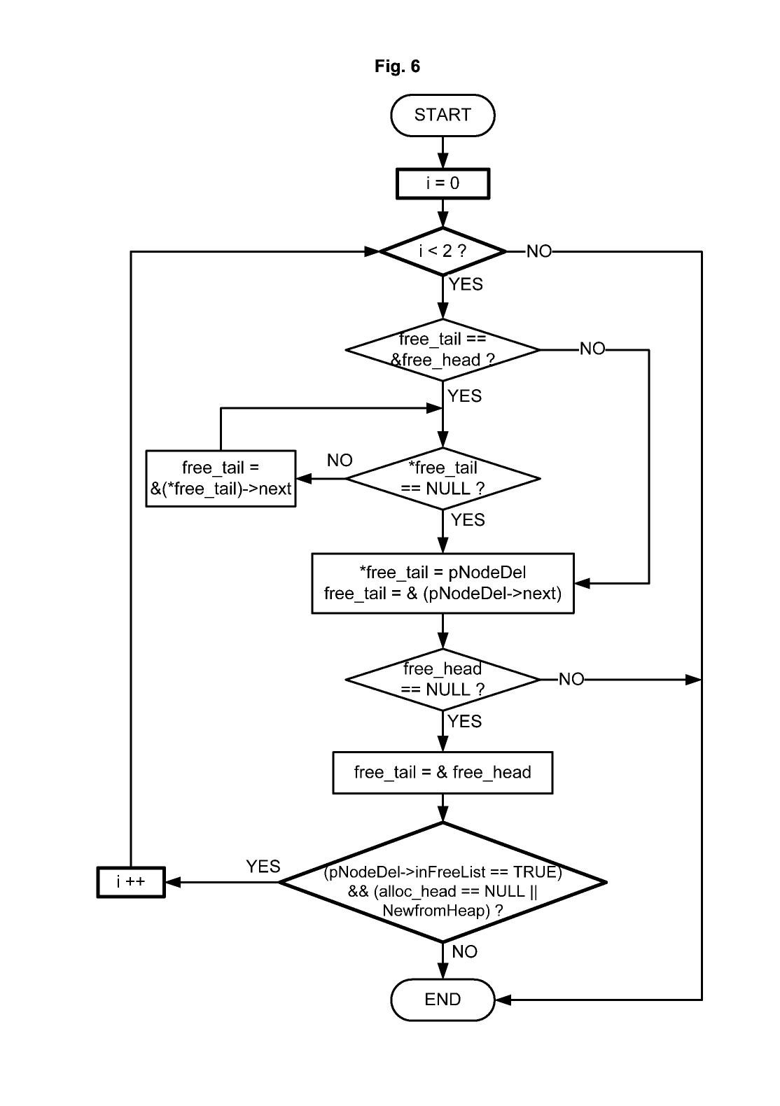

FIG. 6 shows a flowchart of the example producer task with buffer loss detection.

In some embodiments of the present disclosure, the telecommunication equipment having the buffer pool as shown in FIG. 2 may further include a processor configured to perform one or more steps of the above procedure task with buffer loss detection.

The proposed lockless buffer resource management scheme is usually applied to the scenario of one producer which only releases resources and one consumer which only allocates resources. For some cases, the producer may also need to allocate resource. On the other hand, the consumer task may also need to release the unused resource back to the buffer pool.

In this situation, the producer may allocate resource from another separate pool (where only one linked list is enough, since no other task will access the pool) so as to avoid contention with consumer. As the possibility of allocation resource in producer task is NOT high like consumer task, the overhead of managing another pool is still acceptable.

For consumer side, the consumer may release unused resources by inserting an unused buffer object into beginning of allocation list. Because the allocation list is only touched by consumer task itself, it will not bring any contention on allocation list.

The proposed lockless buffer resource management scheme has been proven to decrease at least 60 μs task switch overhead per 1 ms period and achieve about 10% performance increase with full rate user data volume (80 Mbps downlink bandwidth, and 20 Mbps air interface bandwidth).

Other arrangements of the present disclosure include software programs performing the steps and operations of the method embodiments, which are firstly generally described and then explained in detail. More specifically, a computer program product is such an embodiment, which comprises a computer-readable medium with a computer program logic encoded thereon. The computer program logic provides corresponding operations to provide the above described lockless buffer resource management scheme when it is executed on a computing device. The computer program logic enables at least one processor of a computing system to perform the operations (the methods) of the embodiments of the present disclosure when it is executed on the at least one processor. Such arrangements of the present disclosure are typically provided as: software, codes, and/or other data structures provided or encoded on a computer-readable medium such as optical medium (e.g., CD-ROM), soft disk, or hard disk; or other mediums such as firmware or microcode on one or more ROM or RAM or PROM chips; or an Application Specific Integrated Circuit (ASIC); or downloadable software images and share database, etc., in one or more modules. The software, hardware, or such arrangements can be mounted on computing devices, such that one or more processors in the computing device can perform the technique described by the embodiments of the present disclosure. Software process operating in combination with e.g., a group of data communication devices or computing devices in other entities can also provide the nodes and host of the present disclosure. The nodes and host according to the present disclosure can also be distributed among a plurality of software processes on a plurality of data communication devices, or all software processes running on a group of mini specific computers, or all software processes running on a single computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

### ABBREVIATIONS

BS Base Station

eNB evolved Node B;

LTE Long Term Evolution;

MAC Media Access Control;

OS Operating System;

PDCP Packet Data Convergence Protocol;

PDU Packet Data Unit;

RLC Radio Link Control;

TTI Transmission Time Interval;

UP User Plane.

1. A buffer resource management method, in which a buffer pool is configured to have an allocation list and a de-allocation list,
the allocation list includes one or more buffer objects linked by a next pointer in a previous buffer object to a next buffer object, and a head pointer pointing to a buffer object at the head of the allocation list, and
the de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer,
in initialization, the head pointer of the de-allocation list is empty, and the tail pointer of the de-allocation list points to the head pointer itself of the de-allocation list,
the buffer resource management method comprising steps of a takeover action as:
assigning the head pointer of the de-allocation list to the head pointer of the allocation list;
cleaning the head pointer of the de-allocation list to empty; and
having the tail pointer of the de-allocation list pointing to the head pointer itself of the de-allocation list.

2. The buffer resource management method according to claim 1, further comprising steps of:
determining whether or not the allocation list is empty;
if the allocation list is empty, determining whether or not the de-allocation list is empty; and
if the de-allocation list is not empty, performing the steps of the takeover action.

3. The buffer resource management method according to claim 2, further comprising steps of:
if the allocation list is not empty, unlinking the buffer object at the head of the allocation list.

4. The buffer resource management method according to claim 2, further comprising steps of:
if the de-allocation list is empty, allocating a plurality of buffer objects from a heap, and linking the plurality of buffer objects to the allocation list.

5. The buffer resource management method according to claim 1, further comprising steps of a reclamation action as:
having the next pointer of the buffer object at the end of the de-allocation list pointing to a new released buffer object, in which the next pointer of the end of the de-allocation list is addressed by the tail pointer of the de-allocation list; and
moving the tail pointer of the de-allocation list to a next pointer of the new released buffer object.

6. The buffer resource management method according to claim 5, further comprising steps of a post-adjustment action as:
after the new released buffer object is linked into the de-allocation list, determining if the head pointer of the de-allocation list is empty or not; and
if the head pointer of the de-allocation list is empty, having the tail pointer of de-allocation list pointing to the head pointer itself of the de-allocation list.

7. The buffer resource management method according to claim 6, further comprising steps of a re-reclamation action as:
after the post adjustment action, determining whether or not the head pointer of the allocation list is empty and the new released buffer object is still in a released state; and
if the head pointer of the allocation list is empty and the new released buffer object is still in a released state, performing the steps of the reclamation action once more.

8. The buffer resource management method according to claim 5, wherein the steps of the takeover action and the steps of the reclamation action are interleavable at any position.

9. A buffer resource management method, in which a buffer pool is configured to have an allocation list and a de-allocation list,
the allocation list includes one or more buffer objects linked by a next pointer in a previous buffer object to a next buffer object, and a head pointer pointing to a buffer object at the head of the allocation list, and
the de-allocation list includes one or more buffer objects linked by a next pointer in a previous buffer object to a next buffer object, a head pointer pointing to a buffer object at the head of the de-allocation list, and a tail pointer pointing to a next pointer of a buffer object at the end of the de-allocation list, wherein the tail pointer is a pointer's pointer,
in initialization, the head pointer of the de-allocation list is empty, and the tail pointer of the de-allocation list points to the head pointer itself of the de-allocation list,
the buffer resource management method comprising steps of a reclamation action as:
having the next pointer of the buffer object at the end of the de-allocation list pointing to a new released buffer object, in which the next pointer of the end of the de-allocation list is addressed by the tail pointer of the de-allocation list; and
moving the tail pointer of the de-allocation list to a next pointer of the new released buffer object.

10. The buffer resource management method according to claim 9, further comprising steps of a post-adjustment action as:
after the new released buffer object is linked into the de-allocation list, determining if the head pointer of the de-allocation list is empty or not; and
if the head pointer of the de-allocation list is empty, having the tail pointer of de-allocation list pointing to the head pointer itself of the de-allocation list.

11. The buffer resource management method according to claim 10, further comprising steps of a re-reclamation action as:
after the post adjustment action, determining whether or not the head pointer of the allocation list is empty and the new released buffer object is still in a released state; and
if the head pointer of the allocation list is empty and the new released buffer object is still in a released state, performing the steps of the reclamation action once more.

12. (canceled)

13. A telecommunication equipment comprising a buffer pool, wherein the buffer pool is configured to have a de-allocation list, and the de-allocation list comprises:
one or more buffer objects linked by a next pointer in a previous buffer object to a next buffer object,
a head pointer pointing to a buffer object at the head of the de-allocation list, and
a tail pointer pointing to a next pointer of a buffer object at the end of the de-allocation list, wherein the tail pointer is a pointer's pointer.

14. The telecommunication equipment according to claim 13, wherein in initialization, the head pointer of the de-allocation list is empty, and the tail pointer of the de-allocation list points to the head pointer itself of the de-allocation list.

15. The telecommunication equipment according to claim 13, wherein the buffer pool is further configured to have an allocation list, and the allocation list comprises:
one or more buffer objects linked by a next pointer in a previous buffer object to a next buffer object, and
a head pointer pointing to a buffer object at the head of the allocation list.

16. The telecommunication equipment according to claim 13, further comprising a processor configured to perform steps of a takeover action as:
assigning the head pointer of the de-allocation list to the head pointer of the allocation list;
cleaning the head pointer of the de-allocation list to empty; and
having the tail pointer of the de-allocation list pointing to the head pointer itself of the de-allocation list.

17. The telecommunication equipment according to claim 16, wherein the processor is further configured to perform steps of:
determining whether or not the allocation list is empty;
if the allocation list is empty, determining whether or not the de-allocation list is empty; and
if the de-allocation list is not empty, performing the steps of the takeover action.

18. The telecommunication equipment according to claim 17, wherein the processor is further configured to perform steps of:
if the allocation list is not empty, unlinking the buffer object at the head of the allocation list.

19. The telecommunication equipment according to claim 17, wherein the processor is further configured to perform steps of:
if the de-allocation list is empty, allocating a plurality of buffer objects from a heap, and linking the plurality of buffer objects to the allocation list.

20. The telecommunication equipment according to claim 13, further comprising a processor configured to perform steps of a reclamation action as:
having the next pointer of the buffer object at the end of the de-allocation list pointing to a new released buffer object, in which the next pointer of the end of the de-allocation list is addressed by the tail pointer of the de-allocation list; and
moving the tail pointer of the de-allocation list to a next pointer of the new released buffer object.

21. The telecommunication equipment according to claim 20, wherein the processor is further configured to perform steps of a post-adjustment action as:
after the new released buffer object is linked into the de-allocation list, determining if the head pointer of the de-allocation list is empty or not; and
if the head pointer of the de-allocation list is empty, having the tail pointer of de-allocation list pointing to the head pointer itself of the de-allocation list.
